(19) United States
(12) Patent Application Publication
(10) Pub. No.: US 2009/0043819 A1
(43) Pub. Date: Feb. 12, 2009

(54) System and method for document hold management

(75) Inventors: Christy Searl, New York, NY (US); Jillian Munro, Maplewood, NJ (US); Martha Solinger, Pelham, NY (US)

Correspondence Address: LEHMAN BROTHERS INC.;C/O MORGAN, LEWIS & BOCKIUS, LLP, 1111 PENNSYLVANIA AVE. N.W., WASHINGTON, DC, 20004, US

(73) Assignee: Lehman Brothers Inc., New York, NY (US)

(21) Appl. No.: 12/213,987

(22) Filed: Jun. 26, 2008

Related U.S. Application Data
(60) Provisional application No. 60/946,619, filed on Jun. 27, 2007.

(51) Int. Cl. G06F 17/30

(52) U.S. Cl. 707/104.1; 707/E17.044

(57) ABSTRACT

A system includes a legal hold notification tool including a legal hold management module to manage a legal hold issued on an organization, the legal hold management module generating a notification of the legal hold to a user subjected to the legal hold, and a legal hold affirmation module to obtain an affirmation of the legal hold from the user on periodic basis throughout the duration of the legal hold.

This present application claims the benefit of U.S. Provisional Application No. 60/946,619 filed Jun. 27, 2007, which is incorporated herein by reference in its entirety.

### BACKGROUND OF THE INVENTION

1. Field of the Invention

The present invention relates to a system and method for document management, and more importantly, to a system and method for document hold management for legal proceedings.

2. Discussion of the Related Art

When certain legal proceedings are initiated, an organization is required to retain documents that pertain to the legal proceedings if the organization is a party or has a substantial interest in the proceedings. In the prior art, the system and process to manage these documents under the “legal hold” are manual. The responsible attorney generally sends a physical memorandum or an electronic mail (“email”) to the person subject to the hold in the organization requesting that they retain documents related to the legal proceedings. Moreover, because the legal hold placed on the documents generally spans over a significant period of time, no automated process to periodically remind the subjected person of the continuing obligation to retain the relevant documents exist.

### SUMMARY OF THE INVENTION

Accordingly, the present invention is directed to a system and method for document hold management that substantially obviates one or more problems due to limitations and disadvantages of the related art.

An object of the present invention is to provide a system and method for document hold management to assist in locating and gathering documents.

Another object of the present invention is to provide a system and method for document hold management to notify a subject person of a duty to retain documents at matter inception.

Yet another object of the present invention is to provide a system and method for document hold management to regularly remind a subject person to continue to retain documents while the matter is pending.

Still yet another object of the present invention is to provide a system and method for document hold management to create a record of proper notification to the subject person.

Another object of the present invention is to provide a system and method for document hold management to consolidate the legal hold data in an easily accessible location.

Yet another object of the present invention is to provide a system and method for document hold management to reinforce the principle that electronic data are documents for purposes of a legal hold.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system includes a legal hold notification tool including a legal hold management module to manage a legal hold issued on an organization, the legal hold management module generating a notification of the legal hold to a user subjected to the legal hold, and a legal hold affirmation module to obtain an affirmation of the legal hold from the user on periodic basis throughout the duration of the legal hold.

In another aspect, a method includes the steps of creating a legal hold issued to an organization via a legal hold management module, generating a notification of the legal hold to a user subject to the legal hold, and obtaining an affirmation of the legal hold from the user, via a legal hold affirmation, on periodic basis throughout the duration of the legal hold.

In yet another aspect, a computer program product includes a computer readable medium having stored thereon computer executable instructions that, when executed on a computer, configure the computer to perform a method including the steps of creating a legal hold issued to an organization via a legal hold management module, generating a notification of the legal hold to a user subject to the legal hold, and obtaining an affirmation of the legal hold from the user, via a legal hold affirmation, on periodic basis throughout the duration of the legal hold.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a system diagram of an exemplary embodiment of the present invention;

FIG. 2 is a block diagram of an exemplary data model of the present invention;

FIG. 3 is an exemplary embodiment of a legal hold management module in accordance with the present invention;

FIGS. 4A and 4B are exemplary views of an affirmation process screen in accordance with the present invention;

FIG. 5 is an exemplary embodiment of an affirmation module of the present invention;

FIG. 6 is an exemplary view of persons subject to a hold in accordance with the present invention;

FIG. 7 is an exemplary embodiment of a legal hold dashboard in accordance with the present invention;

FIG. 8A-8C are exemplary views of an affirmation status interface in accordance with the present invention;

FIG. 9 is an exemplary view of an affirmation status tab of a legal hold management module in accordance with the present invention;

FIG. 10 is an exemplary embodiment of a legal hold management grid of the present invention;

FIG. 11 is an exemplary embodiment of a legal hold creation screen in accordance with the present invention;

FIG. 12 is an exemplary embodiment of a legal hold modification screen in accordance with the present invention;

FIG. 13 is an exemplary embodiment of a comment screen in accordance with the present invention;

FIG. 14 is an exemplary embodiment of a document upload screen in accordance with the present invention; and

FIG. 15 is an exemplary view of a notification in accordance with the present invention.

### DETAILED DESCRIPTION OF THE INVENTION

Reference will now be made in detail to the embodiments of the present invention, examples of which are illustrated in the accompanying drawings. Wherever possible, like reference numbers will be used for like elements.

The system and method for document hold management in accordance with the present invention is a document retention and notice system. The system and method according to the present invention automates the document retention and notification process by notifying the subject person of the obligation to retain documents, including an initial and periodic affirmation from the notified person that the person is complying with the organization's obligation to retain the documents related to the legal proceedings, and storing the documents related to the hold and affirmation process.

In particular, the primary functions and scenarios in accordance with the present invention include:

Authorized user creates new hold;

Authorized user modifies hold;

Authorized user closes hold;

Authorized user views affirmation status;

System notifies person that they are subject to a hold;

System requires affirmation from the notified person;

System notifies interested parties (e.g., cc:s) that a hold has been issued for affirmation or reaffirmation;

Person subject to the hold affirms;

System notifies legal staff that hold is due for reaffirmation; and

Authorized user adds persons or an organizational group of people to an existing hold, where the system sends an affirmation notice to only those people added (i.e., those who have not yet received notice and affirmed the hold) and does not affect those who already affirmed.

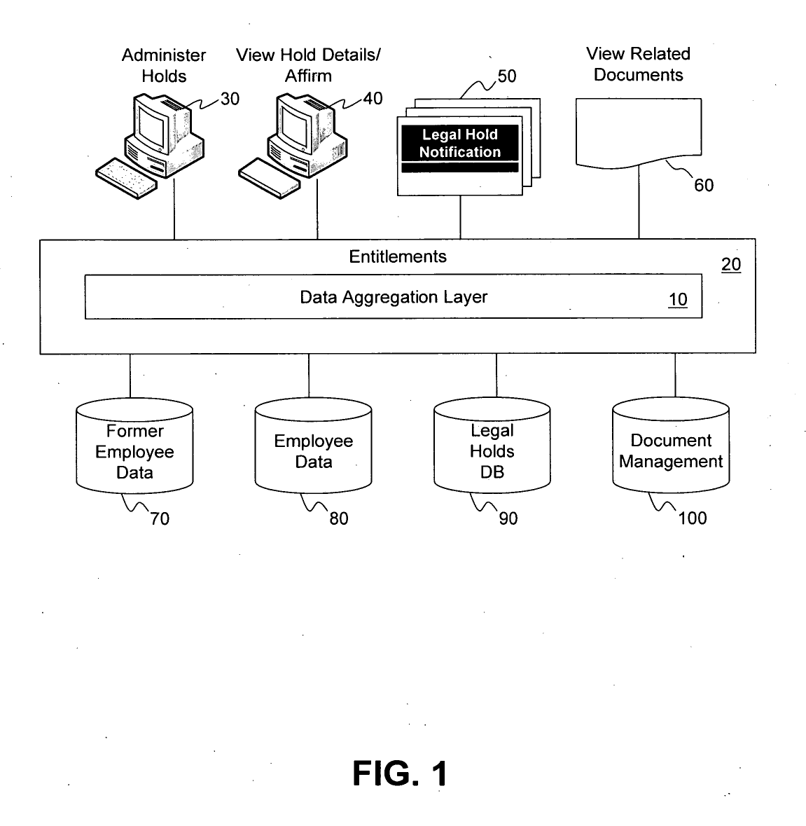

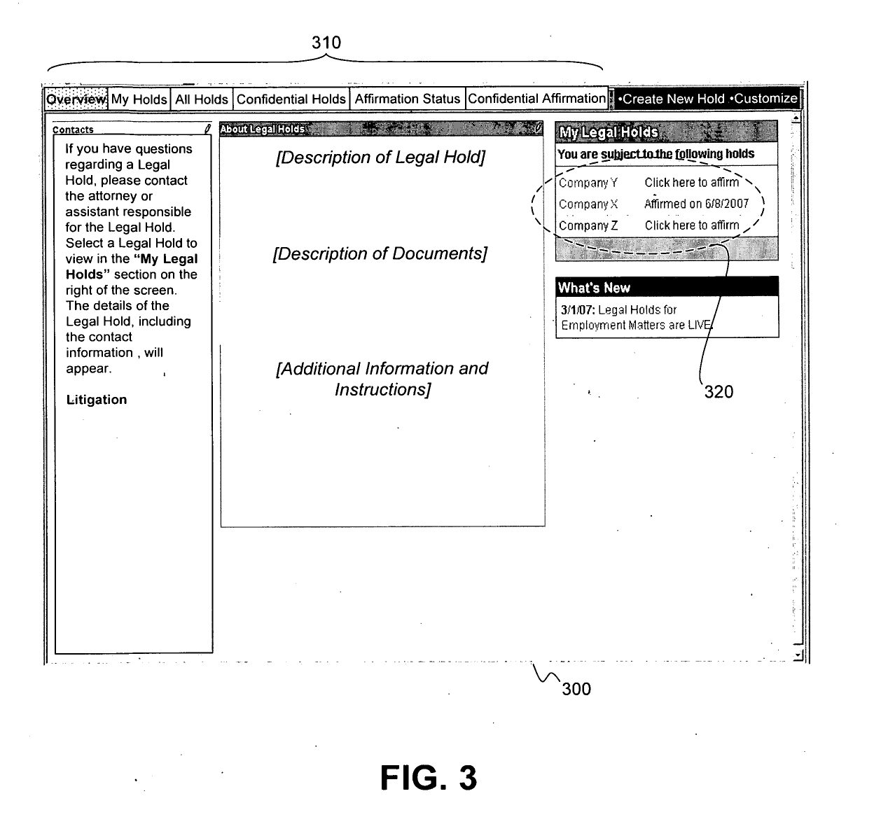

FIG. 1 shows an overall system diagram depicting an exemplary architecture of the system in accordance with the present invention. In an exemplary embodiment of the present invention, the system of the present invention includes a data aggregation layer 10, entitlements layer 20, client device 30 to administer the holds, and client device 40 to view and affirm holds. Client device 40 gains access to legal hold notification tool 50 and the documents related to the hold 60. The legal hold notification tool 50 provides access to the hold information and the documents related to the hold based on the entitlements of the user determined by the entitlements layer 20. In an exemplary embodiment of the present invention, the legal hold notification tool 50 includes a document hold management module 300 (FIG. 3), a user interface application described in detail below, built using a customized development scripting language, such as AJAX based on Tibco's General Interface product.

The data aggregation layer 10 as shown in FIG. 1 may be a combination of custom database tables and a customized asset repository, such as the asset database (ADb) described in U.S. patent application Ser. No. 10/924,572 incorporated herein by reference, for person reference information as well as document information. In general, the ADb (not shown) is a relational database of the organization that contains information of every asset in the organization (e.g., hardware, software, human resources, real estate, etc.) and its relationship with other assets in the organization. In particular, the data aggregation layer 10 includes access to former employee data 70, current employee data 80, legal hold database 90, and document management database 100. The former employee data 70 is used to look up former employees subject to a hold who are no longer with the organization subject to the hold. The current employee data 80 is used to reference existing employees and includes current affirmation status (i.e., whether any outstanding hold affirmation exists). The employee data 70 and 80 may be obtained from the ADb of the organization. The legal holds database 90 includes hold information, including text and other attributes, relationships between holds and people or groups of group subject to the holds, affirmation details from each of the user, and historical affirmation status of every hold in the system. Document management database 100 includes folders with documents related to the hold and manages entitlements by folders. The data aggregation layer 10 shown in FIG. 1 joins data from these different data sources and returns the data in a specialized format, such as XML or CDF to be presented to the client devices 30 and 40. It is to be understood that other computer devices, components, architectures, applications, and scripting languages may be used without departing from the scope of the present invention. For example, the database layer 10 and entitlements layer 20 may be implemented on one or more network servers in communication with the databases 70-100 and client devices 30, 40 via a communication network (not shown). The communication network may be a local area network (LAN), wide area network (WAN), distributed network, such as the Internet, and point-to-point connections. The communication network may be implemented using wired or wireless connections. Other communication networks may be used without departing from the scope of the present invention.

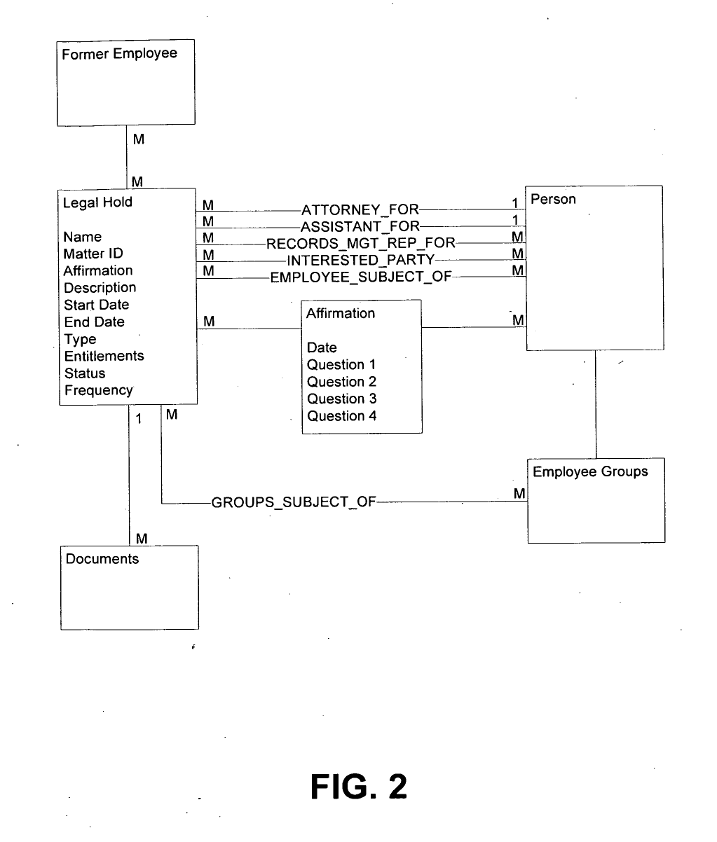

FIG. 2 shows an exemplary logical data model that depicts various relationships between the data in accordance with the present invention. In particular, exemplary fields, their definitions, and valid values in accordance with an exemplary embodiment of the present invention are shown below in Table 1.

TABLE 1

| | | Valid Values | |
|---|---|---|---|
| Field Name | Definition | (if approp.) | Logic/field type |
| Hold Name | Name of the Legal | | Free form text |
| | Hold (typically the | | |
| | case name) | | |
| Matter ID | Relates the hold to a | | Link to new matter management |
| | case in the matter | | system for drop-down select; |
| | management system | | (Free form - optional) |
| Matter P&L | | | P/L picker |
| Affirmation | Brief text describing | | Free form text |
| Description | the hold (1-2 | | |
| | sentences). Displays | | |
| | on the affirmation | | |
| | survey page. | | |
| Hold Start Date | Effective start date of | | Calendar date picker |
| | the hold. This is the | | Drives the affirmation cycle |
| | date from which the | | Current Date |
| | Firm is required to | | (optional: past or the future date |
| | retain documents. | | may be allowed) |
| Hold End Date | Effective end date of | | Calendar date picker |
| | the hold. This is the | | |
| | date on which the | | |
| | Firm is no longer | | |
| | obligated to retain | | |
| | documents. | | |
| Type | Legal area in the firm | Litigation | Drop-down with predefined |
| | responsible for the | Regulatory | values |
| | hold | Tax | |
| Entitlement | Determines if the hold | Regular | Drop-down with predefined |
| | is confidential and is | (open to all | values |
| | entitled to a smaller | members of | |
| | pool of people | Litigation, | |
| | | Regulatory, | |
| | | and Tax | |
| | | Groups) | |
| | | Confidential | |
| | | (open to a | |
| | | discrete set | |
| | | of people | |
| | | who | |
| | | administer | |
| | | sensitive | |
| | | cases) | |
| Status | Describes the state of | Open | Drop-down with predefined |
| | the hold. An | Closed | values |
| | affirmation notice will | | |
| | only go out if the hold | | |
| | has a status of “open”. | | |
| Frequency | The frequency with | 4 months | Drop-down with predefined |
| | which reaffirmations | 6 months | values |
| | take place | 12 months | If “none” is selected, |
| | | None | the hold will never be subject to |
| | | | reaffirmation. |
| Attorney | Attorney in charge of | | People picker |
| | the case. | | Name displays as |
| | | | contact on the hold dashboard. |
| Assistant | Legal Assistant | | People picker |
| | assigned to the case. | | Name displays as |
| | | | contact on the hold dashboard. |
| Records | Records Management | | People picker |
| Management Rep(n) | Representative | | Multiple people may be |
| | assigned to the case. | | assigned, e.g., based on location |
| Applies to P&L | Allows users to make | | P/L picker |
| | entire departments of | | All employees within a P/L |
| | people subject to hold | | become subject to the hold and |
| | by selecting P/L | | receive individual notifications. |
| | groups. | | If an employee leaves a |
| | | | department after a hold is |
| | | | instituted, they remain on the list |
| | | | as an “employee subject to |
| | | | hold”. |
| Employees Subject | Individual employees | | People picker |
| to Hold | subject to document | | |
| | retention as it relates | | |
| | to the case. | | |
| Employees CC | Interested parties who | | People picker |
| | receive an | | |
| | informational | | |
| | notification of the | | |
| | people subject to the | | |
| | hold. | | |
| Former Employees | Record of former | | Former employee people picker |
| | employees who were | | |
| | involved in projects | | |
| | related to the case. | | |
| | There is no logic | | |
| | associated with this | | |
| | field. | | |

As shown in FIG. 2, data are related to each other as many-to-many (M-M) or many-to-one (M-1) relationships. However, other relationships, fields, definitions, and values may be used without departing from the scope of the present invention.

FIG. 3 shows an exemplary embodiment of a legal holds management module in accordance with the present invention. Legal holds management module 300 is an administrative tool to allow the legal staff, such as attorneys and assistants, to create, update, and track the status of the legal holds. The legal holds management module 300 is implemented as a web page application on the client devices 30, 40 including tabs 310 to display various aspects of the legal holds. However, other implementations may be used without departing from the scope of the invention. For example, the exemplary embodiment of FIG. 3 includes the following data tabs: “Overview,” which displays the general information about the legal holds process; “My Holds,” which displays all holds where the user is the attorney or the assistant; “All Holds,” which displays the complete inventory of non-confidential holds; “Confidential Holds,” which displays the complete inventory of confidential holds (i.e., holds with elevated entitlements); “Affirmation Status,” which displays the affirmation status; and “Confidential Affirmation,” which displays affirmation status for all confidential hold.

FIG. 3 shows an exemplary user interface (“UI”) of the “Overview” tab in accordance with an embodiment of the present invention. Examples of the UI may be a web page or portal that opens to an overview page on client devices 30, 40 with informational text and contact information regarding the legal hold. The “Overview” UI of FIG. 3 includes a nugget 320 (i.e., “My Legal Holds”) that shows a personalized view of the holds to which the user is subject, the affirmation status, and the date when the hold was affirmed, for example. Each of the holds listed in the UT may be invoked (e.g., click-through) to allow the user to view and/or affirm the hold.

The system and method in accordance with the present invention disseminates an initial hold notification and periodic notifications thereafter to people subject to the hold informing them that they are subject to one or more legal holds and that affirmation of the legal hold is required. In accordance with the present invention, the hold notifications may be batched and sent at a specified time (e.g., after-hours to alleviate network traffic) or may be sent whenever a new hold is detected in the system.

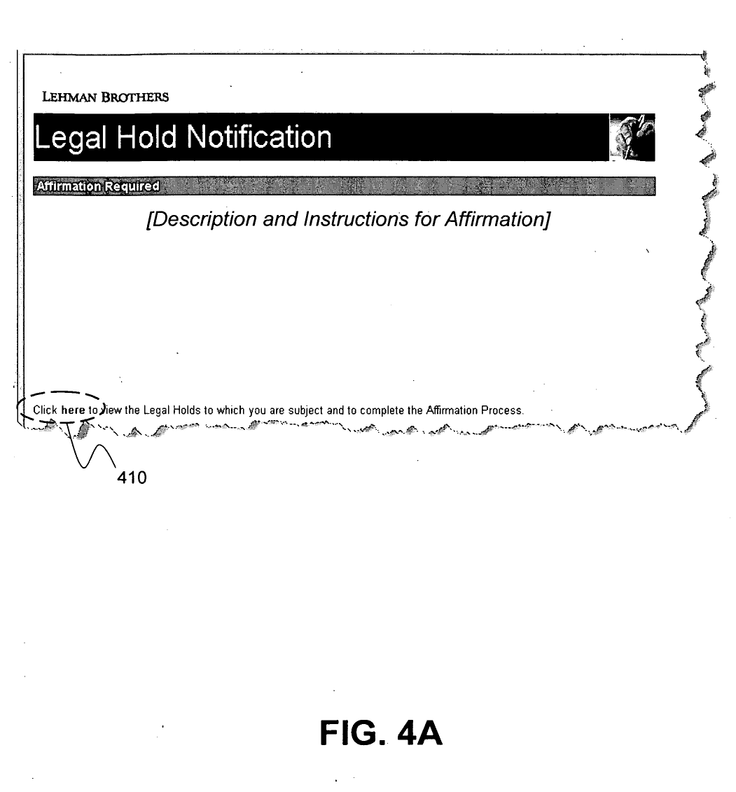

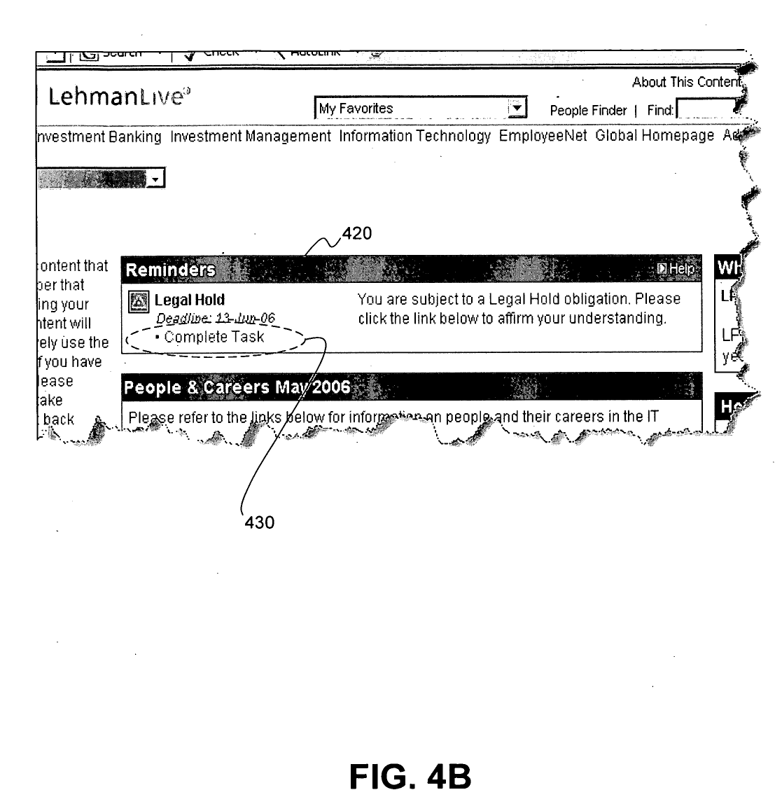

FIG. 4A shows an exemplary notification of a legal hold that a person subject to a legal hold receives via email, for example. The notification may contain a link 410 to the details of the legal hold that allows the person to complete the affirmation process. The periodicity of the notification may be set when first creating or updating the hold details. In addition to, or in the alternative, the system and method in accordance with the present invention provides a reminder 420 on a user's homepage, for example, of the person subject to the legal hold as shown in FIG. 4B. The reminder 420 on the homepage may contain link 430 to the affirmation survey in the legal hold notification tool 50.

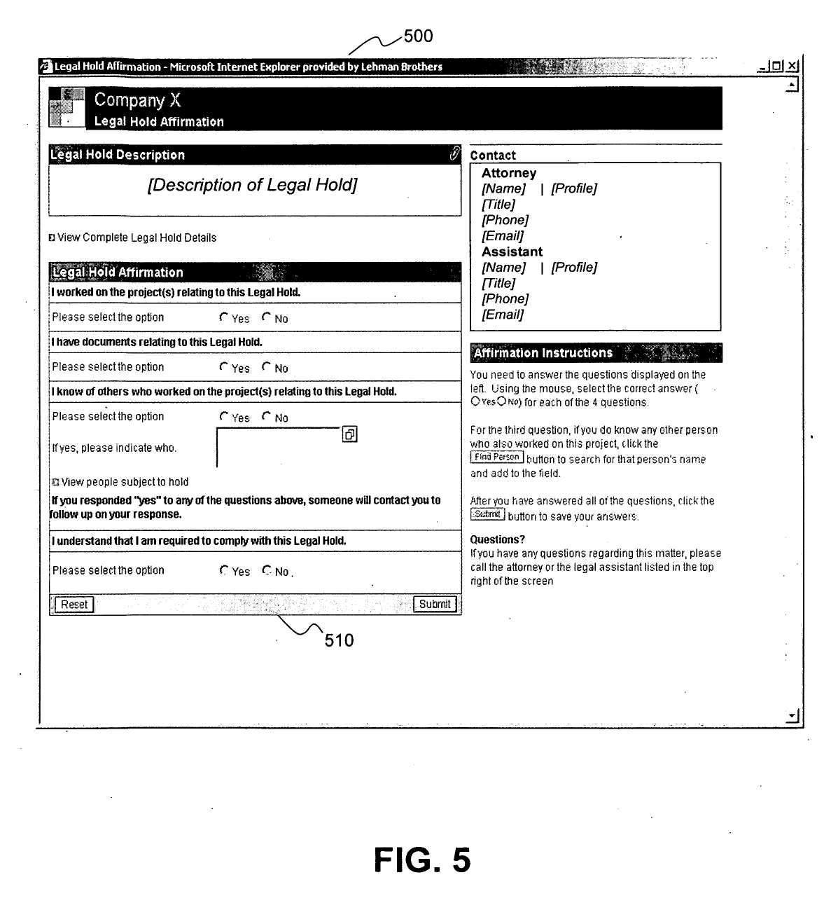

In accordance with an exemplary embodiment of the present invention, a person subject to a hold launches the legal hold affirmation module 500 shown in FIG. 5 by click through link 410 on the email (FIG. 4A) or link 430 on the reminder 420 (FIG. 4B), for example, to affirm the receipt and understanding of the legal hold. For example, the legal hold affirmation module 500 may be a web page where the person is asked to answer several questions 510 to affirm the user's understand of the obligations under the legal hold. The questions may be binary questions to affirm the user's understanding of the obligations under the legal hold, such as:

1) I worked on the project(s) relating to this Legal Hold;

2) I have documents relating to this Legal Hold;

3) I know of others who worked on the project(s) relating to this Legal Hold; and

4) I understand that I am required to comply with this Legal Hold.

The types and numbers of questions may be used without departing from the scope of the invention.

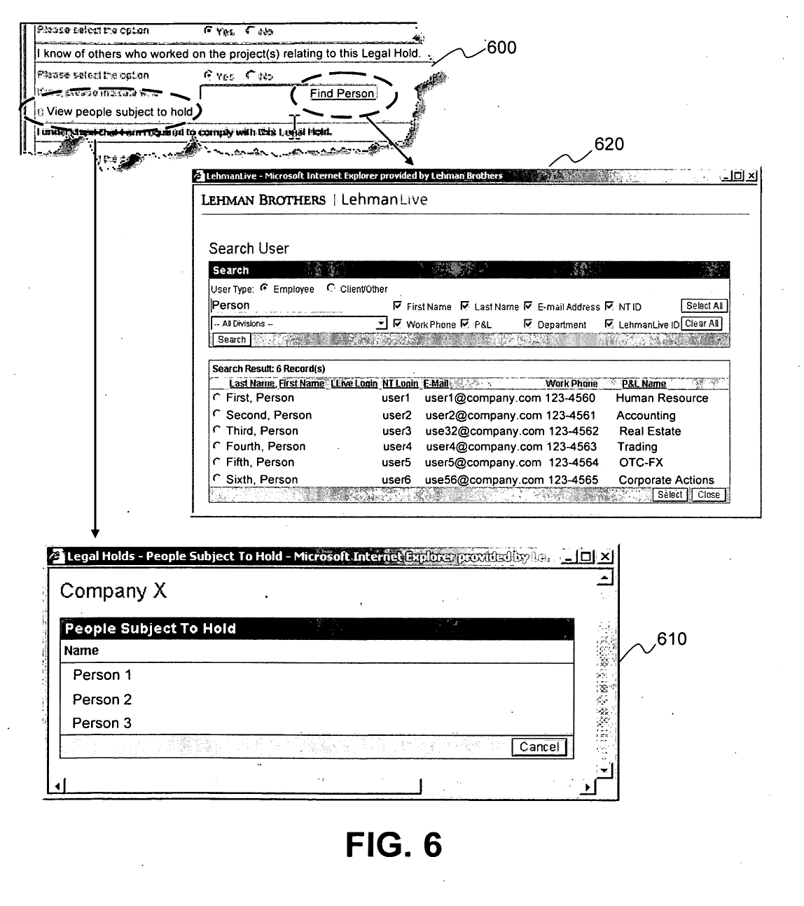

In accordance with an exemplary embodiment of the present invention, the system and method of the present invention provides for persons subject to a hold to help identify other potential persons in the organization that may be subject to the legal hold, thereby allowing the list of the subject persons to be expanded appropriately. As shown in FIG. 6, the legal hold notification tool 50 of an exemplary embodiment of the present invention includes a search and view module 600 to allow the users to (1) view a list of current persons subject to the hold to identify gaps 610, and (2) identify these persons in the system of the present invention 620 through the affirmation module 500.

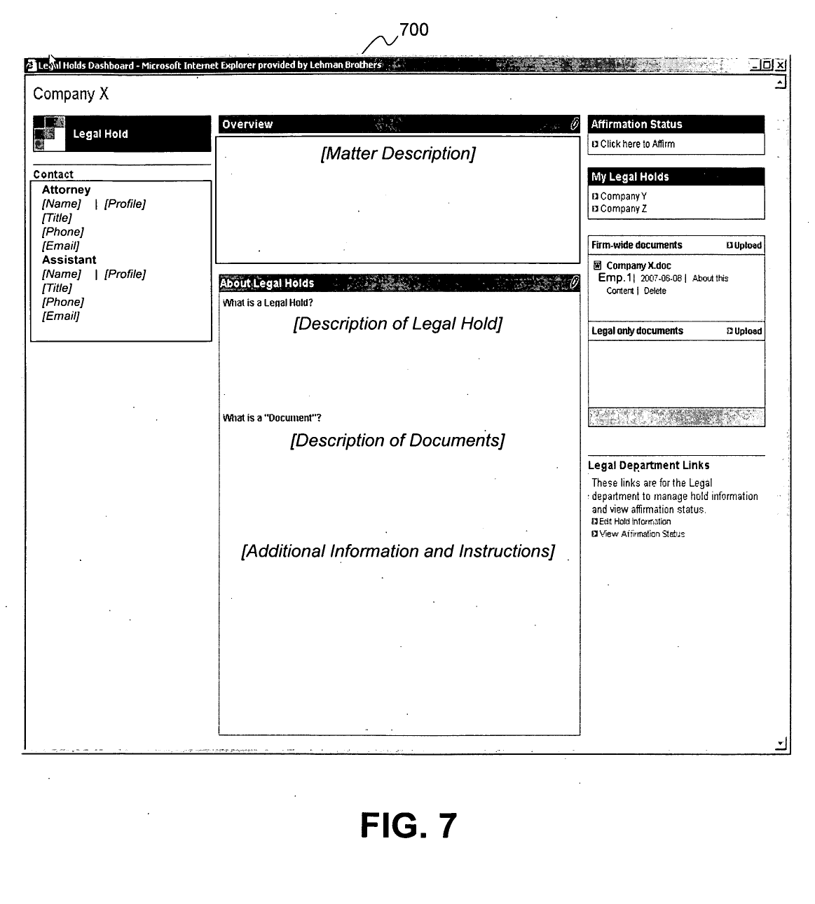

FIG. 7 shows an exemplary legal hold dashboard embodiment of the present invention to facilitate review of the details of a legal hold by the person subject to the hold or a member of the legal team. Dashboard 700 may be implemented as a web page or as a separate application on top of the data aggregation layer 10. Other implementations may be used without departing from the scope of the invention. The dashboard 700 displays detailed information regarding the legal hold, such as legal contacts for the case including the attorney and legal assistants responsible for the matter 710, description of the matter 720, description of the legal hold 730 including description of the documents to be retained 740 and instructions for retaining the documents 750, the subject's affirmation status on the current hold 760, a summary of other holds to which the person is subject 770, and any related documents the viewer is entitled to see 780. Members of the legal team 710, for example, may also edit hold details from the dashboard 700 or review the affirmation status and responses for all persons subject to the hold 790.

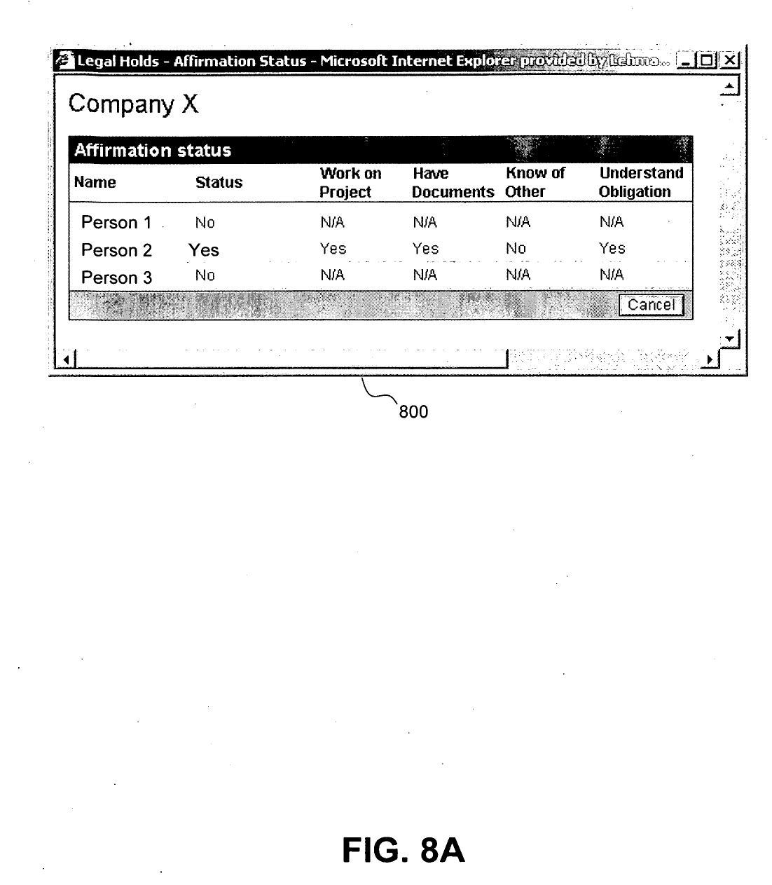

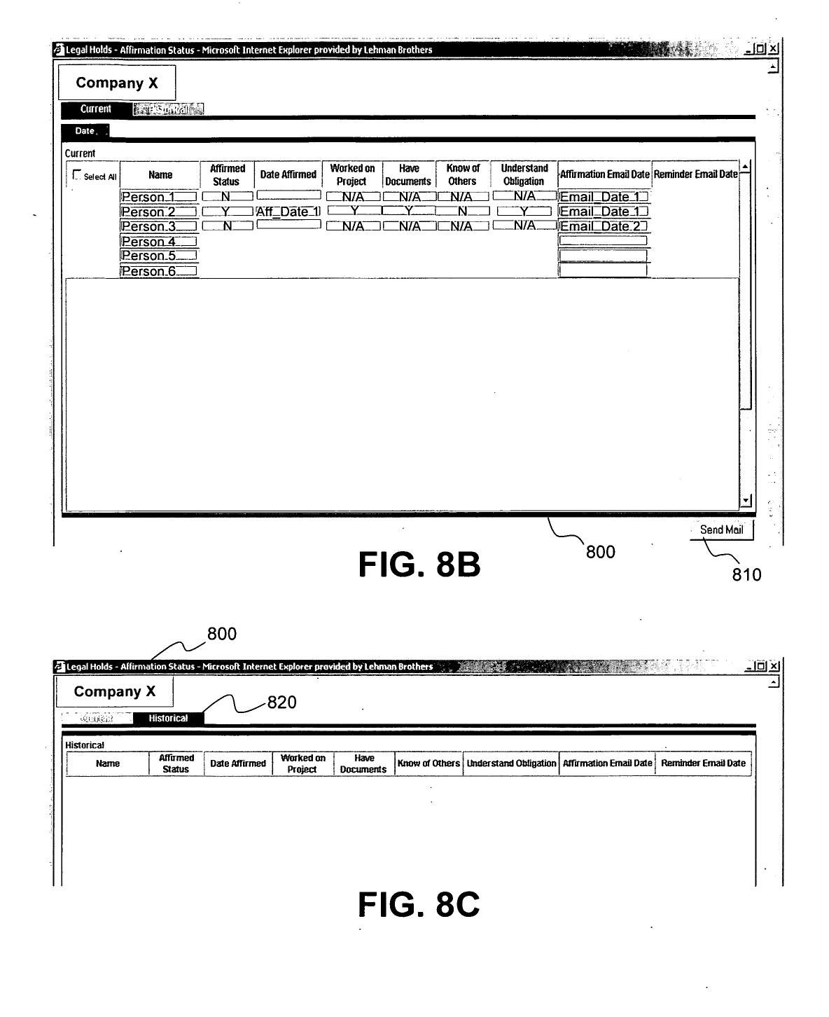

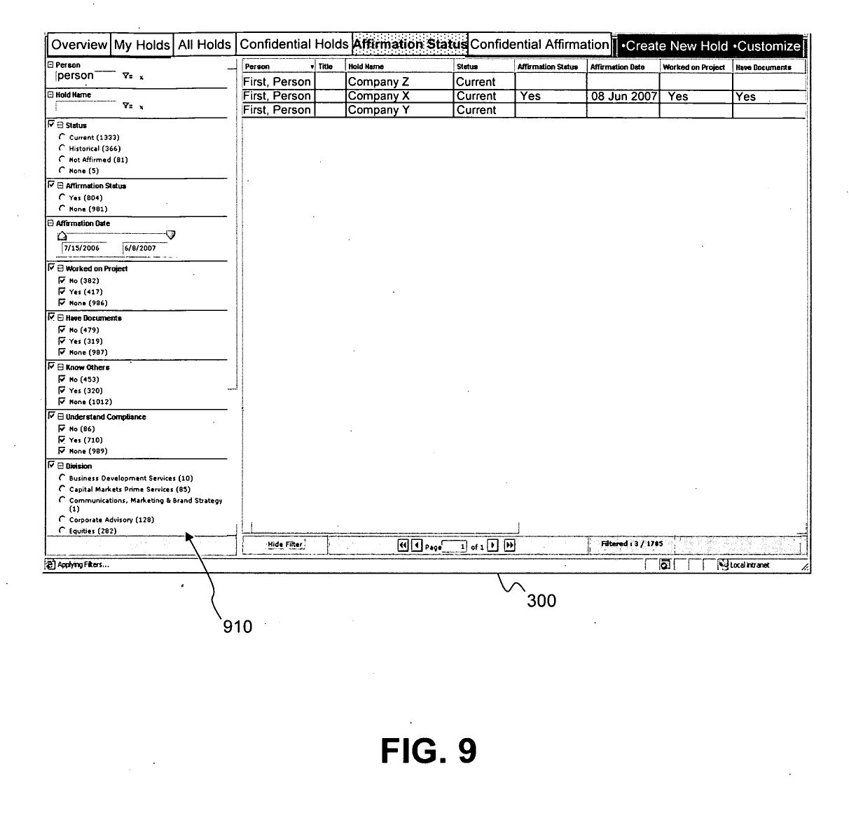

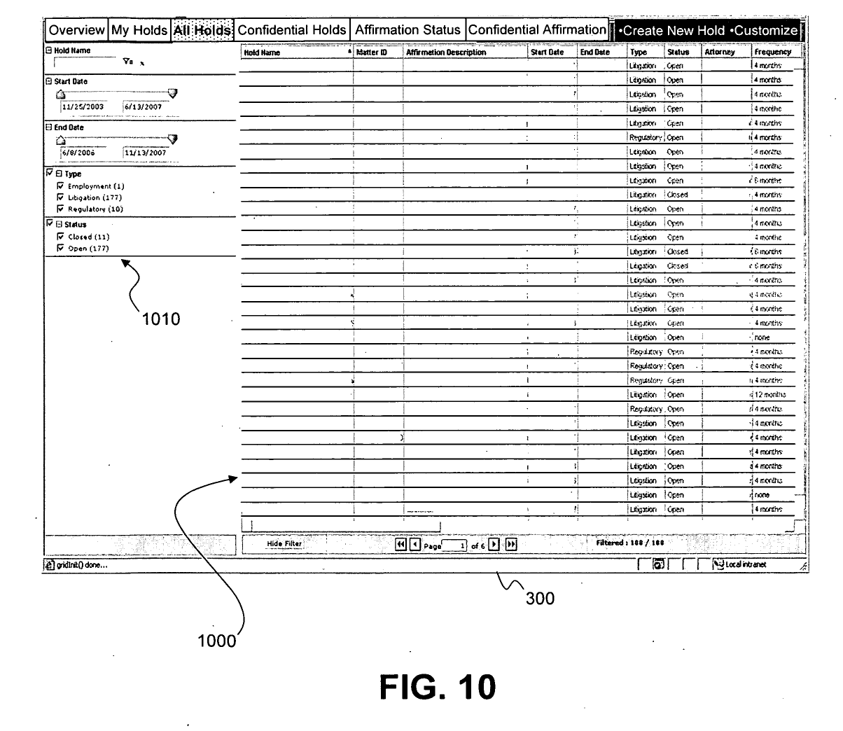

FIG. 8A-8C show an exemplary embodiment of an affirmation status UI. The legal team, for example, may view the overall affirmation status of a hold from the legal hold dashboard 700 (FIG. 7) or the affirmation status tab 910 on the main legal holds management module 300 (FIG. 9), for example. FIG. 8A shows an exemplary view of the main affirmation status display of the affirmation status UI 800. As shown in FIG. 8A, the main affirmation status information displayed on the affirmation status UI 800 includes affirmation status of each hold (e.g., legal hold “Company X”), such as the name of the person subject to the hold (“Name”), whether the subject person has affirmed the obligation of the hold (“Status”), and how the subject person responded to each of the questions (e.g., FIG. 5) asked during the affirmation process (e.g., “Worked on Project,” “Have Documents,” “Know of Others,” “Understand Obligation”). FIG. 8B is an exemplary embodiment of an expanded view that also includes when the people subject to a legal hold were notified (e.g., “Affirmation Email Date”) and when any reminders were sent (e.g., “Reminder Email Date”). For example, if a person has not yet affirmed a hold, (e.g., FIG. 8B, “Person 1”), a reminder notification may be sent (e.g., “Send Mail” 810) manually or automatically after a set period of time has passed without an affirmation. Additionally, the exemplary embodiment of the present invention generates periodic reminders to re-affirm the hold and tracks continued affirmation status throughout the duration of the legal hold. FIG. 8C shows an exemplary embodiment of the affirmation status UI 800 that includes a history view 820 of the people subject to the hold and the affirmation status throughout the duration of the hold. Alternatively, FIG. 9 shows the “Affirmation Status” tab in the legal holds management module 300 displaying the same information, but allows the reviewer to sort and filter by any attribute (e.g., person, case name, affirmation status, etc.) using attribute filter 910. Other attributes may be used with the attribute filter 920 without departing from the scope of the invention.

FIG. 10 shows an exemplary embodiment of a legal holds management grid in accordance with the present invention. As shown in FIG. 10, the legal holds management grid 1000 is a UI implemented under the “All Holds” tab on the legal holds management module 300. The legal holds management grid 1000 displays all of the legal holds of the organization and the status of the holds. An attribute filter 1010 may be used to filter the information to view specific holds based on the attributes of the hold.

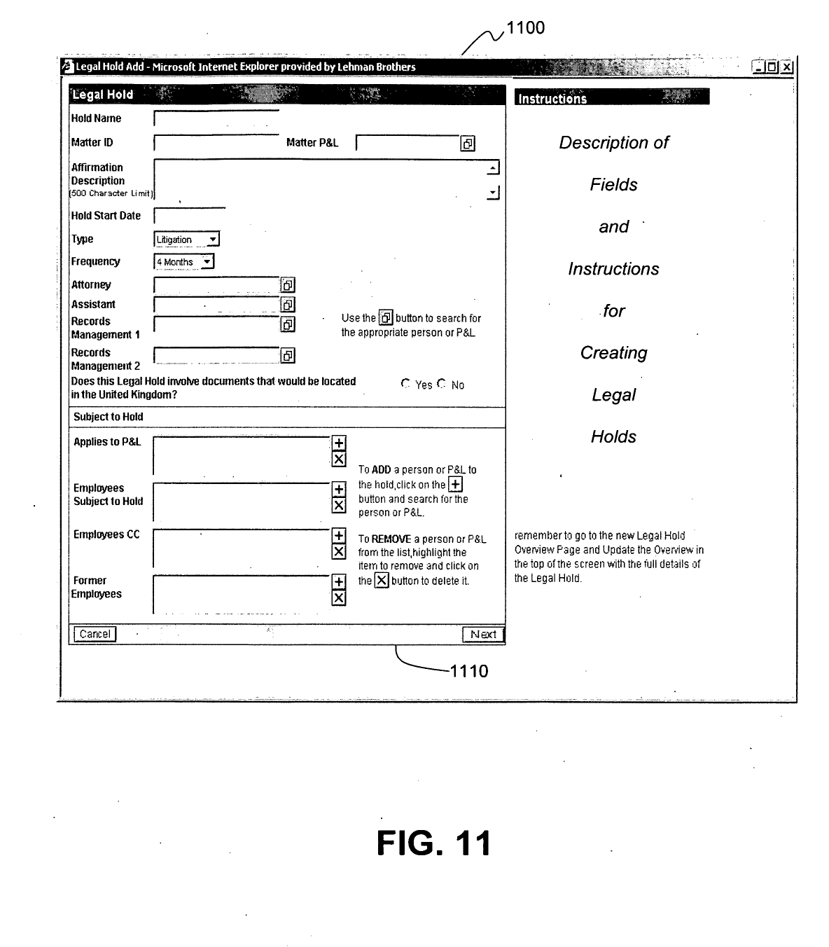

The legal hold management module 300 in accordance with an exemplary embodiment of the present invention includes a legal hold creation/edit module 1100. To create a new hold, the legal hold management module 300 includes a link on the top right hand portion of the page, for example, to invoke the legal hold creation/edit module 1100. By selecting the “create new hold” link on the top of the legal holds management module 300, the legal hold creation module launches a Create New Hold screen 1110 as shown in FIG. 11, for example, to allow a user to create a new hold. The user is provided with instructions and descriptions to enter the necessary information to create the hold, such as the hold name, matter ID, matter P&L (profit/loss group), description of the hold, hold start date, type of hold, frequency of the affirmation, legal staff in charge of the hold, records management personnel, and the identify of those subject to the hold. Those subject to the hold may be identified individually (e.g., current employees, former employees, etc.) and/or by group (e.g., all employees assigned to a P&L group).

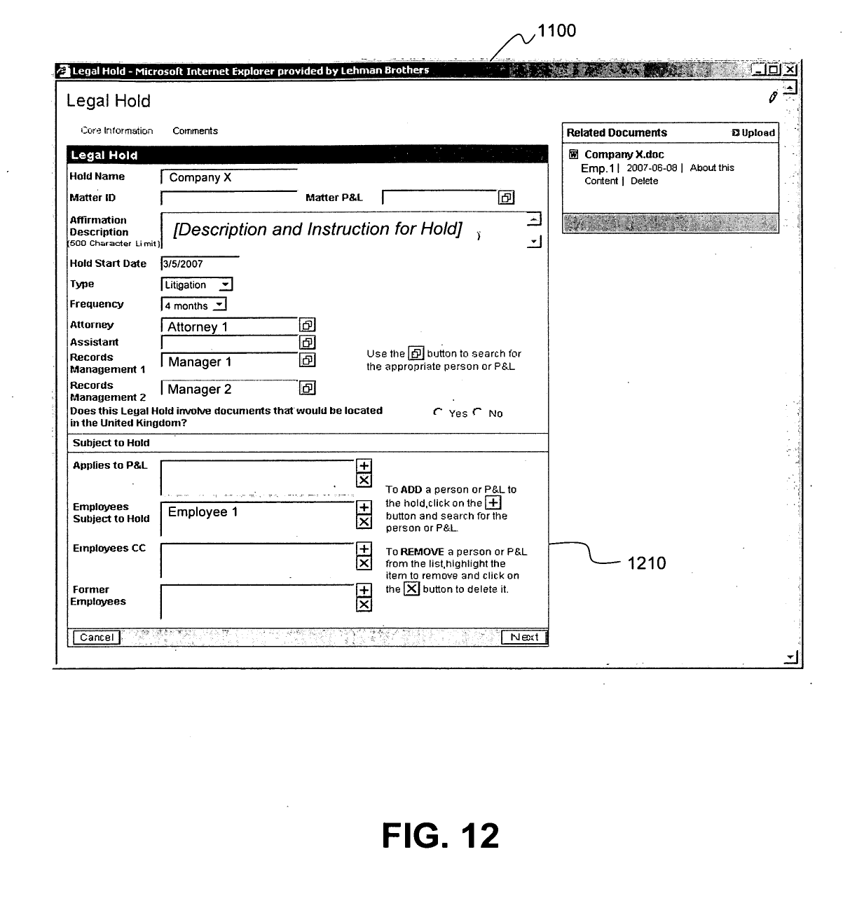

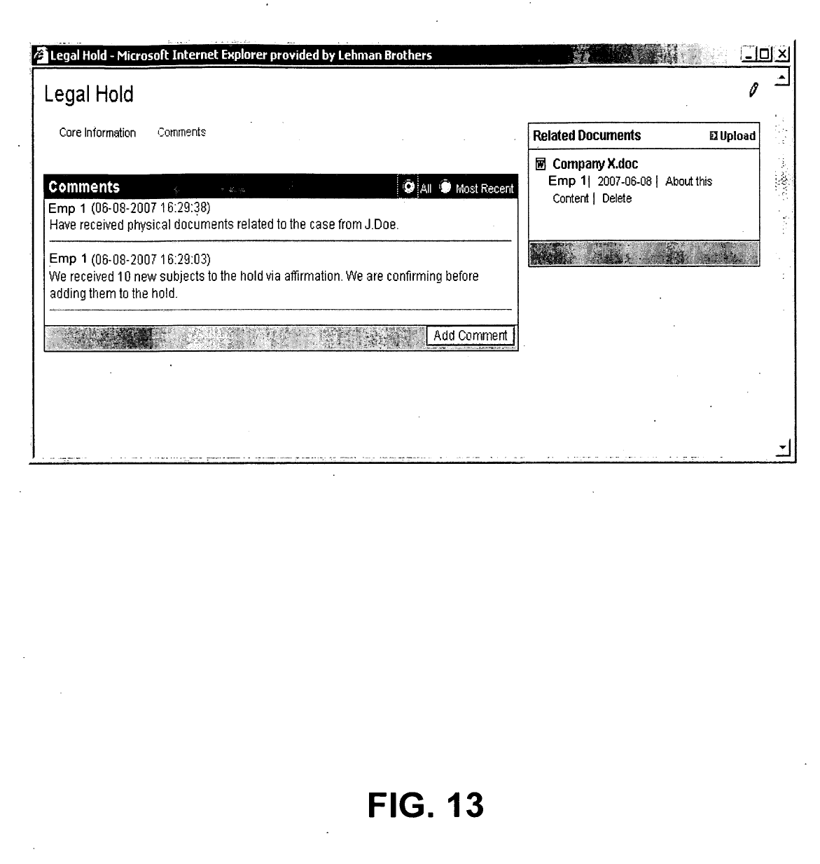

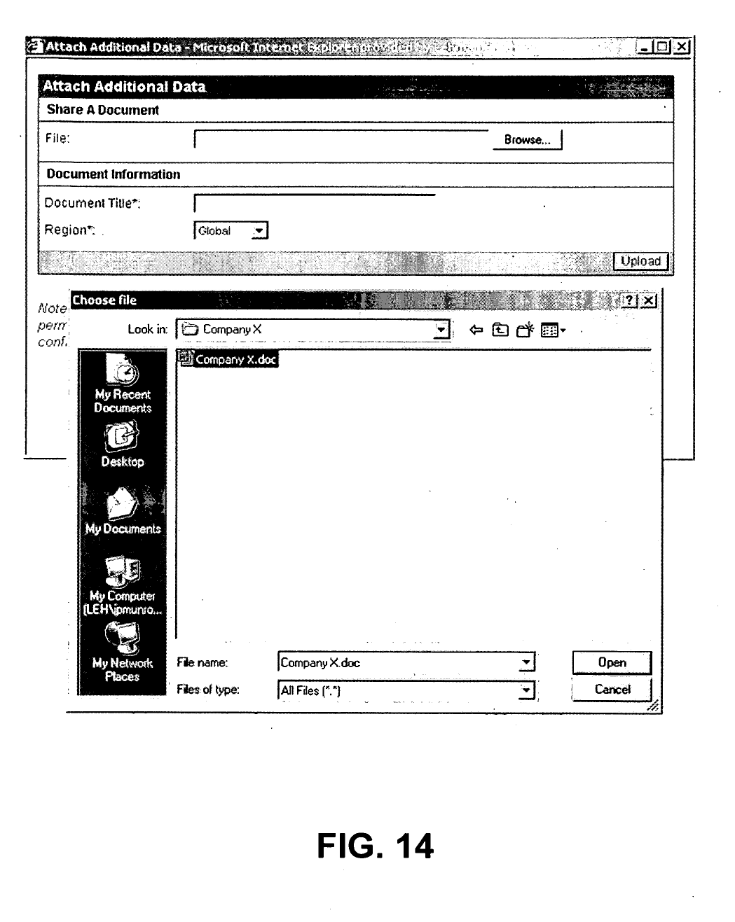

To make modifications or add comments to an existing hold, a user only has to select a hold from the legal holds management grid 1000, for example, to invoke the legal hold creation/edit module 1100. FIG. 12 shows an exemplary embodiment of an Edit Legal Hold screen 1210. The Edit Legal Hold screen 1210 allows an entitled user (i.e., user identified by the entitlements layer 20) to modify the hold information. The Edit Legal Hold screen 1210 may be identical to the Create New Hold screen 1110 with the fields already populated, or may be a different interface. If a new person subject to the hold is added to the hold, the subject person will receive a notification to affirm without affecting the remaining subjects or their responses. From this screen, users can enter running commentary on the hold that is date/time/user stamped and uneditable, for example, and add files that are indexed to the hold either in a folder that is accessible to the entire organization, or entitled to the legal department, for example. The Edit Legal Hold screen 1210 is accessible to the legal team from the legal hold dashboard (FIG. 7) or the main legal hold management grid (FIG. 10). From the Edit Legal Hold screen 1210, members of the legal team, for instance, can log and view comments (FIG. 13) or add documents related to the case (FIG. 14).

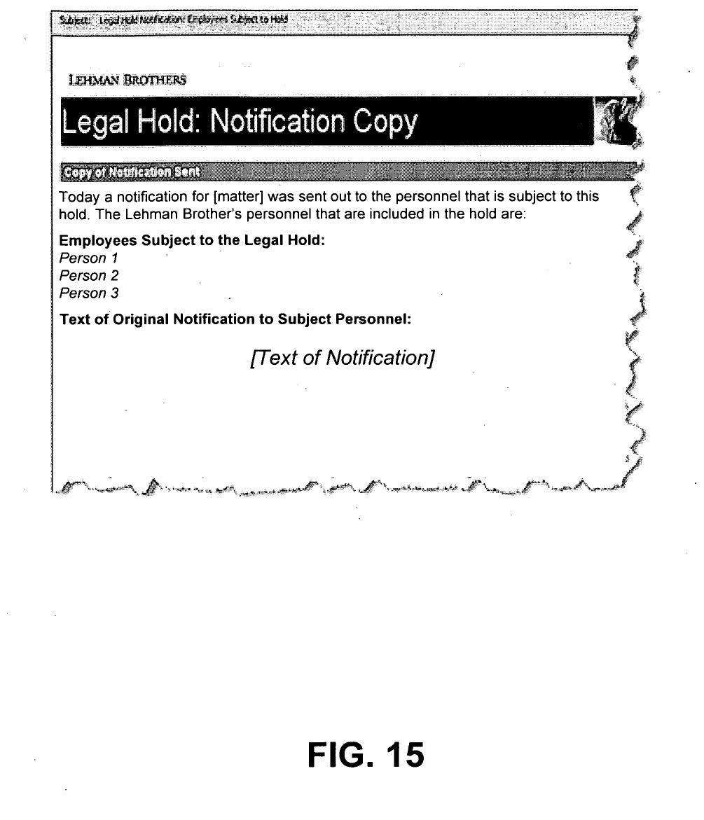

Interested parties, such as attorneys, legal assistants, records management representative, and others identified as interested parties receive an informational copy of the notification when the hold is activated or ready for reaffirmation. FIG. 15 shows an exemplary embodiment of a notification issued in accordance with the present invention. The notification displays, for example, a list of the employees subject to the hold. In addition, the attorneys, legal assistants, and others overseeing the hold receive a reminder notification (e.g., via email) within a predefined time period before a hold is ready for reaffirmation. This allows them to verify all information about the hold before a reaffirmation notice goes out to the subjects.

As described above, the system and method for document hold management in accordance with the present invention offers many benefits and improvements, such as convenient and simplified platform (e.g., web-based) that deploys within the organization's existing system infrastructure (e.g., intranet infrastructure); personalized view of holds for subjects, as well as for legal staff, such as attorneys and assistants overseeing the hold; single, generic notification to subjects for all holds that apply to them; modularity for tapping into existing organization-central data for people information; periodic reminders to attest and reaffirm; convenience of allowing for groups or individuals to be assigned as subject to a hold; and persistent record of the hold details, case description, and retention of documents and communications. Moreover, the system and method of the present invention obtains entitlements and employee information by leveraging the information available in the ADb of the organization to accurately identify those subject to the hold and the documents related to the hold.

It will be apparent to those skilled in the art that various modifications and variations can be made in the system and method for document hold management in accordance with the present invention without departing form the spirit or scope of the invention. Thus, it is intended that the present invention cover the modifications and variations of this invention provided they come within the scope of the appended claims and their equivalents.

What is claimed is:

1. A system, comprising:
a legal hold notification tool including a legal hold management module to manage a legal hold issued to an organization, the legal hold management module generating a notification of the legal hold to a user subjected to the legal hold, and a legal hold affirmation module to obtain one or more affirmations of the legal hold from the user throughout the duration of the legal hold.

2. The system of claim 1, further comprising a data aggregation layer to aggregate data from one or more databases, the data including employee data related to the legal hold.

3. The system of claim 1, wherein the legal hold management module identifies one or more documents related to the legal hold.

4. The system of claim 1, wherein the legal hold affirmation module includes a questionnaire to identify other users to be subjected to the legal hold.

5. The system of claim 1, wherein the legal hold management module monitors the status of the legal hold and the one or more affirmations of the user.

6. A computer-implemented method, comprising the steps of:
creating a legal hold for an organization;
sending a notification of the legal hold to a user subject to the legal hold; and
obtaining one or more affirmations of the legal hold from the user throughout the duration of the legal hold.

7. The method of claim 6, further comprising aggregating data from one or more databases, the data including employee data related to the legal hold.

8. The method of claim 6, further comprising identifying one or more documents related to the legal hold.

9. The method of claim 6, further comprising sending a questionnaire to identify other users to be subjected to the legal hold.

10. The method of claim 6, further comprising monitoring the status of the legal hold and the one or more affirmations of the user.

11. A computer program product including a computer readable medium having stored thereon computer executable instructions that, when executed on a computer, configure the computer to perform a method comprising the steps of:
creating a legal hold issued to an organization;
sending a notification of the legal hold to a user subject to the legal hold; and
obtaining one or more affirmations of the legal hold from the user throughout the duration of the legal hold.

12. The computer program product of claim 11, further comprising computer executable instructions that, when executed on the computer, configure the computer to aggregate data from one or more databases, the data including employee data related to the legal hold.

13. The computer program product of claim 11, further comprising computer executable instructions that, when executed on the computer, configure the computer to identify one or more documents related to the legal hold.

14. The computer program product of claim 11, further comprising computer executable instructions that, when executed on the computer, configure the computer to send a questionnaire to identify other users to be subjected to the legal hold.

15. The computer program product of claim 11, further comprising computer executable instructions that, when executed on the computer, configure the computer to monitor the status of the legal hold and the affirmations of the user.
